(19) United States
(12) Patent Application Publication
(10) Pub. No.: US 2016/0089958 A1
(43) Pub. Date: Mar. 31, 2016

(54) VEHICULAR POWER SYSTEM FOR STOP-START HVAC SYSTEM

(71) Applicant: DENSO International America, Inc., Southfield, MI (US)

(72) Inventor: Patrick POWELL, Farmington Hills, MI (US)

(21) Appl. No.: 14/863,849

(22) Filed: Sep. 24, 2015

Related U.S. Application Data
(60) Provisional application No. 62/055,221, filed on Sep. 25, 2014.

(51) Int. Cl. B60H 1/32; B60H 1/00

(52) U.S. Cl. CPC B60H 1/3208; B60H 1/00428; B60H 1/0045; B60H 1/00778; B60H 1/3222; B60H 2001/00928

(57) ABSTRACT

A vehicular system includes a compressor and a power system. The power system may include a battery pack having a plurality of batteries, a switch device, and a motor-generator. The switch device includes a plurality of switches that are electrically coupled to each of the batteries of the battery pack. The switches are operable to control each of the batteries of the battery pack. The motor-generator is electrically coupled to the switch device and is operable as a generator for charging the batteries in the battery pack and as a motor for driving the compressor when the engine is stopped during an idle state of the vehicle.

### CROSS-REFERENCE TO RELATED APPLICATIONS

This application claims the benefit of U.S. Provisional Application No. 62/055,221, filed on Sep. 25, 2014.

### FIELD

The present disclosure relates to a power system for a vehicle and, more particularly, to a power system for operating an HVAC system disposed in the vehicle that has a stop-start system.

### BACKGROUND

This section provides background information related to the present disclosure which is not necessarily prior art.

To reduce carbon emission and increase fuel economy, vehicles can include a stop-start system in which an internal combustion engine is stopped when the vehicle is idle and is started when the vehicle begins to travel. While the engine is stopped, any device that may depend on the engine may not operate.

As an example, a heating, ventilation, and air conditioning (HVAC) system may include a compressor that is driven by the engine by way of a clutch. The compressor supplies refrigerant to a refrigeration cycle of the HVAC system. With the engine stopped, the compressor cannot supply refrigerant to the HVAC system which can, therefore, prevent the HVAC system from properly cooling a passenger compartment of the vehicle.

### SUMMARY

This section provides a general summary of the disclosure, and is not a comprehensive disclosure of its full scope or all of its features.

The present disclosure is directed toward a power system for powering an air conditioning system of a vehicle. The power system includes a battery pack that has a plurality of batteries, a switch device, and a motor-generator. The switch device includes a plurality of switches that are electrically coupled to each of the batteries of the battery pack and are operable to control each of the batteries of the battery pack. The switch device may control a single battery independently of the other batteries, and may also couple two or more batteries in parallel and/or in series. The motor-generator is electrically coupled to the switch device and is operable as a generator to charge the batteries in the battery pack and as a motor to drive a compressor of the air conditioning system.

More particularly, in an aspect of the present disclosure, the vehicle includes an internal combustion engine that can be stopped when the vehicle is idle. The motor-generator may operate as the motor to drive the compressor when the engine is stopped due to an idle state of the vehicle. Accordingly, the compressor may continue to operate to cool air provided to a passenger compartment of the vehicle when the engine is stopped.

Further areas of applicability will become apparent from the description provided herein. The description and specific examples in this summary are intended for purposes of illustration only, and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates a system for a vehicle having a stop-start system for controlling an internal combustion engine during an idle state;

FIG. 2 is a schematic of a portion of a switch device having electrical switches coupled to batteries of a battery pack;

FIG. 3 is a functional block diagram of a power control module;

FIG. 4 is an example of a vehicle-battery guideline for controlling the operation of the batteries via the switch device;

FIG. 5 is a functional block diagram of a switch device; and

FIG. 6 is a flowchart of an example air conditioning control routine.

Corresponding reference numerals indicate corresponding parts throughout the several views of the drawings.

### DETAILED DESCRIPTION

A vehicle having a stop-start system for controlling an engine during an idle state of the vehicle may include a compressor that relies on the mechanical energy from the engine to operate. Some stop-start vehicles may include cold storage packs that cool air flowing through the HVAC system when the compressor is not working. However, such vehicles may not effectively control the temperature within the passenger cabin of the vehicle.

A power system of the present disclosure includes a motor-generator that operates to power the compressor when the engine is stopped and to charge the batteries in the battery pack when the engine is on. In addition to supplying power to the compressor, the power system also supplies power to one or more accessory devices. Specifically, the power system includes a switch device for controlling the operation of multiple batteries in a battery-pack. The switch device electrically couples the accessory devices and the motor-generator to different batteries within the battery pack.

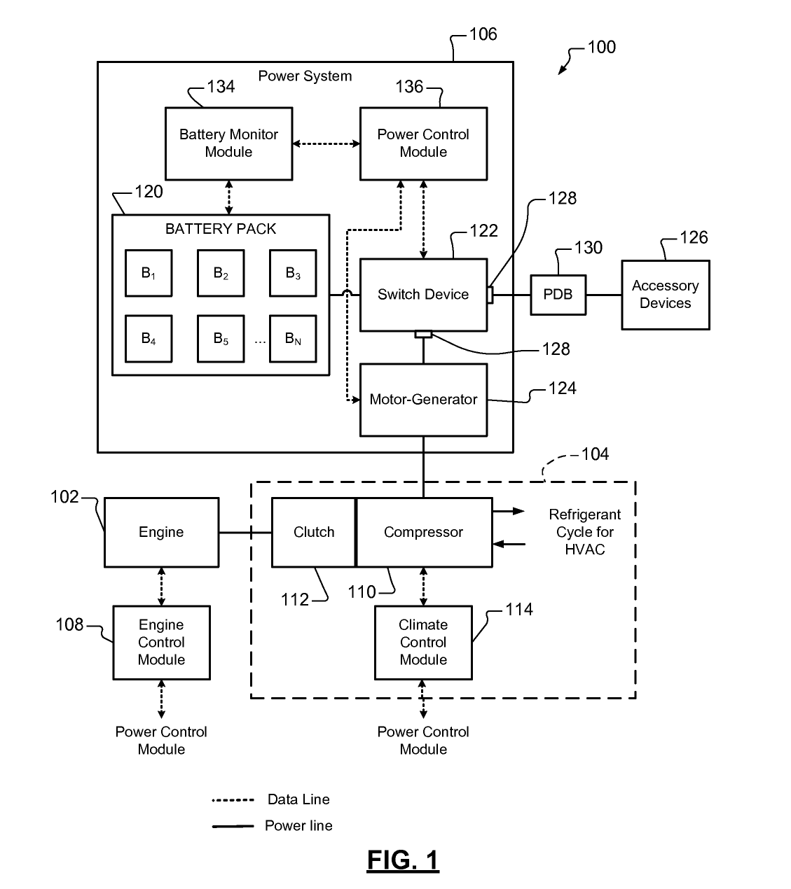

The present disclosure will now be described more fully with reference to the accompanying drawings. With reference to FIG. 1, a system 100 for a vehicle includes an internal combustion engine 102; a heating, ventilation, and air conditioning (HVAC) system 104; and a power system 106. The vehicle may be a hybrid vehicle or have a conventional internal combustion system that has a stop-start system for controlling the engine 102. In the stop-start system, the engine 102 is automatically shut down during a stop (i.e., idle condition) and restarts when, for example, the brake is released and/or when pressure is applied to an accelerator. The start-stop system reduces the amount of time the engine 102 spends idling, thereby reducing fuel consumption and emissions. An engine control module 108 may control the operation of the engine 102 for the stop-start system, and may output information to the power system 106 indicating when the engine 102 has been stopped/started.

The HVAC system 104 conditions air to a desired temperature for a passenger compartment of the vehicle. The HVAC system 104 includes a compressor 110 that supplies refrigerant to a closed loop cooling cycle of the HVAC system 104. A clutch 112 powers the compressor 110 by way of the engine 102. As an example, the compressor 110 is driven by a belt attached to the engine 102 which is engaged by the clutch 112. When the clutch 112 is engaged, the compressor 110 pumps refrigerant through the closed loop cooling cycle. Accordingly, as long as the engine is in operation, the compressor 110 may be powered by the engine 102.

The HVAC system 104 may also include a climate control module 114 that monitors and controls the components of the HVAC system 104. The climate control module 114 may output information to the power system 106 regarding an operation state of devices within the HVAC system 104, such as the compressor 110, blowers, and sensors.

The power system 106 supplies power to electronic devices including the compressor 110. The power system 106 includes a battery pack 120, a switch device 122, and a motor-generator 124. The battery pack 120 includes multiple batteries (B₁, B₂, . . . , B_{N}, where N is an integer), which may be collectively referred to as “batteries B.” The batteries B may have the same voltage or different voltages, such as 12V and/or 24V.

The switch device 122 controls each battery B within the battery pack 120 to provide power to one or more devices in the vehicle and/or to charge the battery B. Specifically, the vehicle may include multiple devices that require the same electrical voltage (i.e., a standard-power device) and may also include one or more other devices that require a larger amount of electrical voltage (i.e., a high-power device). The switch device 122 controls the batteries B to supply power to both standard-power devices and high-power devices. In addition, the switch device 122 may electrically couple the batteries B to a power source to charge the batteries B.

The switch device 122 is coupled to accessory devices 126 and the motor-generator 124 via ports 128. The accessory devices 126 are standard-power devices and may include starters, fans, LCDs, power seats, exterior lights, interior lights, and/or other electrical devices that may require a standard voltage (e.g., 12V or 24V). In the example embodiment, the accessory devices 126 are coupled to the switch device 122 by way of a power distribution board (PDB) 130. Each low voltage device having the same power voltage requirement is coupled to the PDB 130, and the PDB 130 is electrically coupled to the switch device 122 at one of the ports 128. The PDB 130 distributes the voltage to the accessory devices 126. Alternatively, each accessory device 126 may be directly coupled to the switch device 122 by way of a designated port 128.

The motor-generator 124 may be considered a high-power device and may require, for example, 48V. The motor-generator 124 may operate as a motor to power the compressor 110 or as a generator to convert mechanical power to electrical power. When operating as the motor, the motor-generator 124 receives power from one or more batteries B of the battery pack 120 via the switch device 122. When operating as the generator, the motor-generator 124 acts a power source to charge one or more batteries B of the battery pack 120 via the switch device 122. As described further below, the motor-generator 124 is operated as the motor when the engine 102 is stopped during idle in order to power the compressor 110 and operates as the generator to charge the battery pack 120 when the engine 102 is operating/running.

The switch device 122 controls the electrical connection of the battery pack 120 to the accessory devices 126 and the motor-generator 124. For example, the switch device 122 may electrically couple the battery B1 to the PDB 130 to supply 12V to the accessory devices 126, and electrically couple batteries B2, B3, B4, and B6 in series to supply 48V to the motor-generator 124. In addition to coupling two or more batteries in series, the switch device 122 may electrically couple two or more batteries B in parallel. Accordingly, the switch device 122 may connect an individual battery B to a port and/or connect multiple batteries B in series and/or in parallel.

The switch device 122 includes a plurality of electrical switches that are operable to electrically couple the batteries B to the motor-generator 124 and/or the PDB 130. The electrical switches are positioned to electrically couple two or more batteries in parallel or in series. In particular, the switch device 122 is connected to the positive and negative terminals of each of the batteries to control a given battery individually and/or to control multiple batteries in series/parallel.

As an example, FIG. 2 illustrates a configuration in which solid state switches, such as metal-oxide-semiconductor field-effect transistors (MOSFETs), are utilized for controlling the connection of the batteries B. In FIG. 2, MOSFETs K1-K9 perform as switches to electrically couple batteries B1 to B4 in parallel or in series. When electrical current is applied to the gate of a given MOSFET, current flows between the drain and the source. Thus, the MOSFET acts as a closed switch between the drain and the source. When electrical current is not applied to the gate, current is prevented from flowing between the drain and the source and, thus, the MOSFET operates as an open switch. Accordingly, when current is applied to the gates of MOSFETS K1-K6, the batteries B1 to B4 are electrically coupled in parallel to output 12V. When current is applied to the gates of MOSFETS K7 to K9, the batteries B1 to B4 are electrically coupled in series to output 48V. While the solid state switches are illustrated as MOSFETs, other suitable electrical switches may be used, such as field-effect transistors.

With continuing reference to FIG. 1, the power system 106 further includes a battery monitor module 134 and a power control module 136. The battery monitor module 134 monitors the operating conditions within the battery pack 120 and of each battery B. As an example, the battery monitor module 134 may monitor the charge-discharge rate of each battery B, the temperature of the battery pack 120, the state of charge (SOC) of each battery B, and/or other information for determining the condition and the life of the batteries B. The battery monitor module 134 may receive information from sensors disposed within the battery pack 120, such as a temperature sensor for monitoring temperature within the battery pack 120, a voltage sensor monitoring the voltage of each battery B, or a charge current sensor for monitoring the current supplied to the battery for charging the battery B. Based on the information from the sensors and predetermined algorithms, the battery monitor module 134 may determine each of the operating conditions provided above.

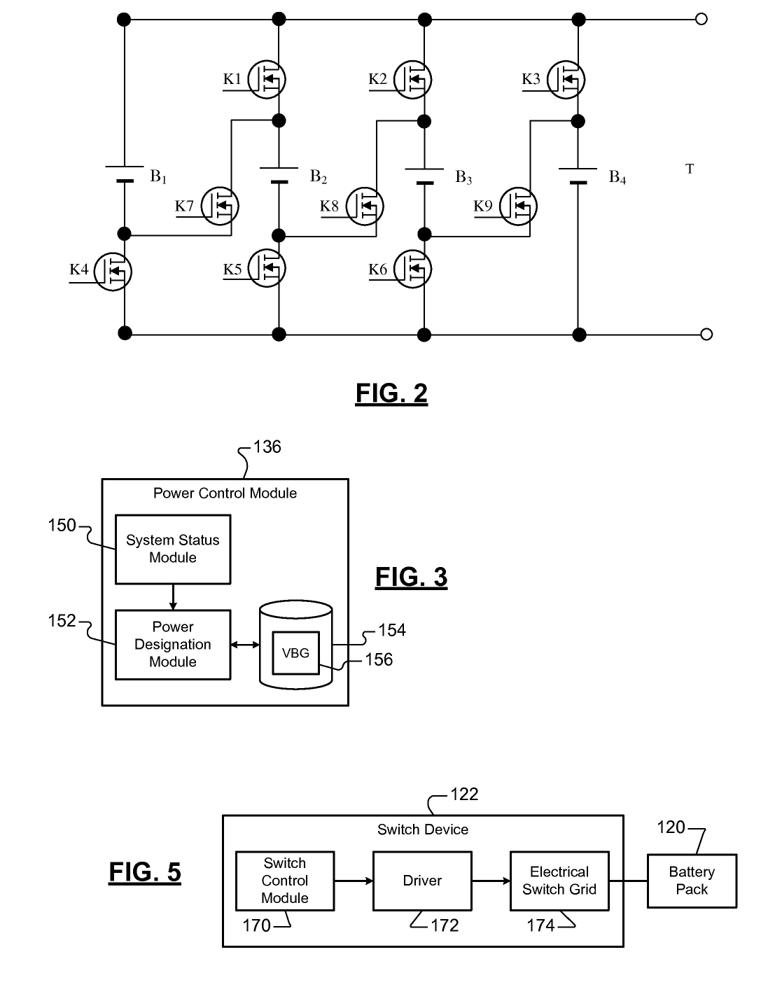

The power control module 136 controls the operation of the batteries B via the switch device 122 and of the motor-generator 124 based on the operation state of the engine 102 and the compressor 110. With reference to FIG. 3, the power control module 136 includes a system status module 150 and a power designation module 152. The system status module 150 determines the operation state of the engine 102 and the compressor 110 as active or inactive based on information from the engine control module 108 and the climate control module 114. Specifically, the system status module 150 receives information regarding the operation state of the engine 102 and information regarding the operation state of the compressor. The system status module 150 may communicate with modules 108 and 114 via a vehicle network, such as a CAN or a LIN.

The power designation module 152 determines the connection of the batteries B with respect to the motor-generator 124 and the accessory devices 126. More particularly, the power control module 136 includes a vehicle-battery repository 154 that stores predetermined vehicle-battery guidelines (VBG) 156. The vehicle-battery repository 154 is a storage device, such as a non-volatile memory. The vehicle-battery guidelines 156 associate the operation state of the engine 102 and the compressor 110 with the operation of the power system 106. The vehicle-battery guidelines 156 may take various suitable forms, such as predefined look up tables and/or control processes.

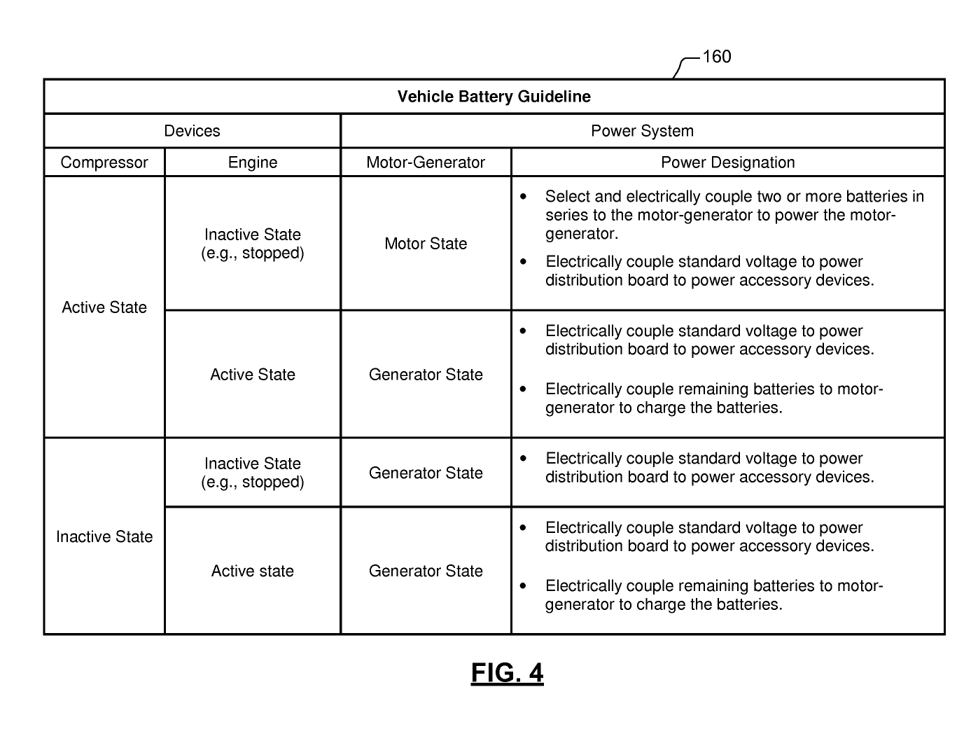

As an example, FIG. 4 illustrates an example of a vehicle-battery control guideline 160. The vehicle battery control guideline 160 identifies various operation scenarios of the vehicle system (i.e., vehicular conditions) and defines a power supply allocation for each of the scenarios. For example, if the compressor 110 is in the active state (i.e., may require power) and the engine 102 is in the inactive state (i.e., stop state) due to an idle state of the vehicle, the power system 106 controls the motor-generator 124 as a motor to drive the compressor 110 and controls the switch device 122 to provide the requisite power to the motor-generator 124, such as 48V. With the compressor 110 in the active state and the engine 102 in the active state, the power control module 136 controls the motor-generator 124 in a generator to charge the batteries B of the battery pack 120. The guideline 160 also indicates a scenario in which the compressor 110 is in the inactive state and the engine 102 is in either the inactive state or the active state. For each of the scenarios provided in the guideline 160, the power system 106 supplies standard voltage (i.e.,12V) to the accessory devices 126.

Using the vehicle-battery guidelines 156 and the operation condition of each battery B provided by the battery monitor module 134, the power designation module 152 determines the operation of each battery B. Specifically, the power designation module 152 determines if the batteries B are to be coupled to a particular port 128 to supply power, which of the batteries B should be electrically coupled to each other and/or to the ports 128, and/or which of the batteries should be charged. The power designation module 152 may select a given battery based on, for example, the SOC or charge-discharge rate of the battery.

The power designation module 152 transmits a command signal to the switch device 122 for establishing the electrical connection of the batteries B. The command signal identifies a battery set to be coupled to a specific port for supplying power to a device connected to the port and/or to be charged. For example, the command signal may identify battery B1 as a battery set to be coupled to the port 128 connected to the PDB 130 and may identify, as a second battery set, batteries B2, B3, B4, and B5 coupled in parallel and to the port 128 connected to the motor-generator 124 for charging.

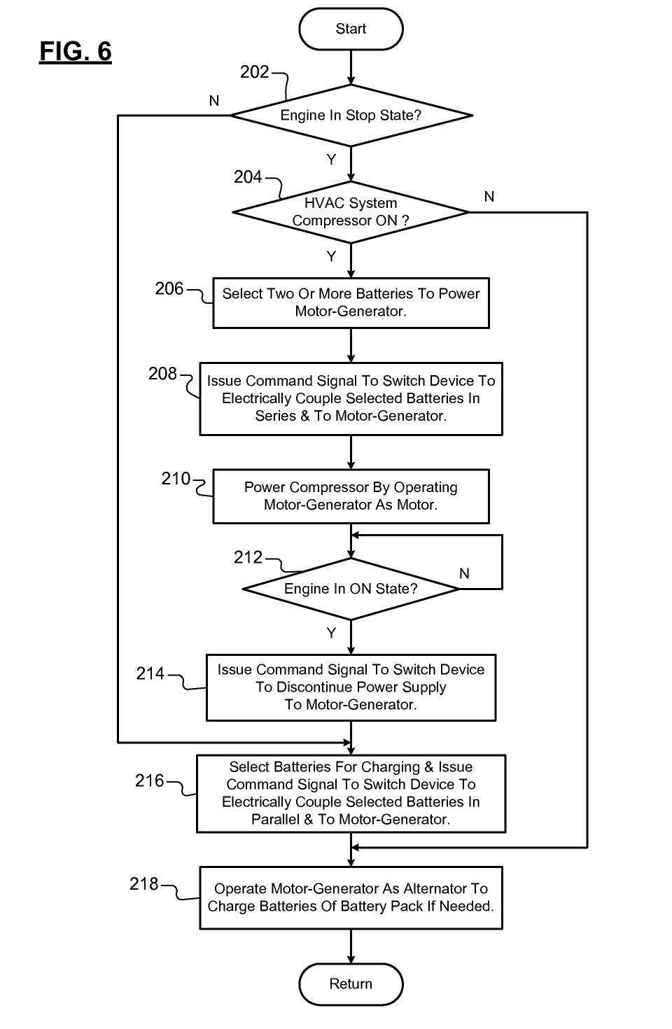

With reference to FIG. 5, the switch device 122 includes a switch control module 170 and a driver 172. The electrical switches used for connecting the batteries B are collectively illustrated as an electrical switch grid 174. The driver 172 is electrically coupled to each electrical switch of the switch grid 174 to actuate a given switch. The switch control module 170 receives the command signal from the power control module 136 and determines which switches are to be actuated for establishing the required electrical connection indicated in the command signal. The driver 172 transmits a current pulse to one or more desired switches in order to establish the electrical connection. Accordingly, the switch device 122 is able to electrically connect one or more batteries to the motor-generator 124 and/or to the PDB 130.

In addition to controlling the switch device 122, the power designation module 152 controls the motor-generator 124 in the motor state or in the actuator state. More particularly, the power designation module 152 may transmit a signal to the motor-generator 124 to switch the operation state of the motor-generator 124.

With reference to FIG. 6, an example of an HVAC system control routine for a stop-start system is provided. The routine may be performed by the power system 106 and may be started when the vehicle is started via the ignition system. Once the vehicle is started via the ignition, the engine control module 108 controls the engine via the stop-start system for idle control.

At 202, the routine determines whether the engine 102 is in the stop state due to the vehicle being idle. For example, the power system 106 may determine whether the engine 102 is stopped based on information from the engine control module 108.

If the engine 102 is in a stop state, the power system 106 determines whether the compressor 110 is ON at 204. That is, the power system 106 determines whether the compressor 110 should be on to supply refrigerant to the HVAC system 104. The power system 106 may determine whether the compressor 110 is ON based on information from the climate control module 114.

If the compressor 110 is ON (Active state), the power system 106 selects two or more batteries to power the motor-generator 124 at 206 and issues the command signal to electrically couple the two or more batteries in series and to the motor-generator 124 at 208. At 210, the power system 106 operates the motor-generator 124 as a motor to power the compressor 110 and, at 212, determines whether the engine is in an ON state due to the vehicle no longer being idle.

Based on the information from the engine control module 108, the power system 106 determines whether the engine 102 is ON. If the engine 102 is ON, the power system 106 issues a command signal to the switch device 122 to discontinue the power supply to the motor-generator at 214. At 216, the power system selects one or more batteries that may need to be charged and issues a command to the switch device 122 to couple the selected batteries to the motor-generator 124. The power system 106 may determine which batteries need to be charged based on the charge state of the batteries. At 216, the power system 106 operates the motor-generator 124 as a generator to charge the selected batteries. At 202, if the engine 102 is not in the stop state, the power system 106 charges the batteries at 216 and 218. At 204, if the compressor is not ON, the system 106 operates the motor-generator 124 as a generator to charge the batteries at 218. The routine continues until the vehicle is shut off.

While not provided in the routine of FIG. 6, the power system 106 allocates at least one battery from among the battery pack 120 to power the accessory devices 126 regardless of the state of the engine 102 and/or the state of the compressor 110.

In operation, the system 100 is able to provide cool conditioned air to the passengers of the vehicle even when the engine 102 is stopped during idle. Specifically, with the engine 102 stopped, the power system 106 operates the motor-generator 124 as a motor for driving the compressor 110. The power system 106 powers the motor-generator 124 by way of, for example, four 12V batteries coupled in series to output 48V to the motor-generator 124. While the power system 106 powers the motor-generator 124, the power system 106 may also supply power to accessory devices 126 via the PDB 130. For example, a 12V battery from among the batteries of the battery pack 120 may be electrically coupled to the PDB 130 to power the accessory devices 126.

The power system 106 includes the switch device 122 for controlling the electrical connection of the batteries B with the motor-generator 124 and the accessory devices 126. The switch device 122 is able to meet the varying power requirements of the devices provided in the vehicle by, for example, electrically coupling two or more batteries in series and/or in parallel while at the same time selecting a specific battery to supply power to the PDB 130. Thus, the power system 106 is able to meet power demand of the system 100 without additional components like DC-DC converters.

In addition to powering the compressor 110, the motor-generator 124 can also be controlled to move the vehicle as part of creep operation. More particularly, with a vehicle not having the stop-start system, when a driver releases the brake, the vehicle may move or creep without applying any pressure to the accelerator. In the example embodiment, with the engine 102 in the off state, the motor-generator 124 can operate in the motor state to move the vehicle a short distance (e.g., 50 ft.). For example, with the valves of the engine 102 open, the motor-generator 124 can receive power from the battery pack 120 via the switch device 122. The motor-generator 124 would power the compressor 110, and the compressor 110 may drive the clutch 112 to actuate the pistons in the engine 102 causing movement of the vehicle via the drivetrain.

The engine control module 108 monitors the amount of pressure on the brake and/or the accelerator, and may request the power system 106 to perform a creep operation when the amount of pressure on the brake and/or the accelerator is below a certain threshold. The power system 106 can increase power to the motor-generator 124 until the requisite power is above an operation threshold of the motor-generator 124 and/or the engine control module 108 terminates the creep operation.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

What is claimed is:

1. A power system for powering an air conditioning system of a vehicle, the power system comprising:
a battery pack having a plurality of batteries;
a switch device including a plurality of switches, wherein the switches are electrically coupled to each of the batteries of the battery pack and are operable to control each of the batteries of the battery pack; and
a motor-generator electrically coupled to the switch device wherein the motor-generator is operable as a generator to charge the batteries in the battery pack and as a motor to drive a compressor of the air conditioning system.

2. The power system of claim 1 wherein the switch device electrically couples two or more batteries in series and to the motor-generator to provide power to the motor-generator.

3. The power system of claim 1 wherein the switch device electrically couples two or more batteries in parallel and to the motor-generator to charge the batteries via the motor-generator.

4. The power system of claim 1 further comprising:
a power control module controlling the switch device and the motor-generator, wherein:
the power control module operates the motor-generator as the motor to drive the compressor when a first vehicular condition is met and operates the motor-generator as the generator when a second vehicular condition is met,
the power control module outputs a command signal to the switch device, the command signal identifies one or more batteries to be coupled to the motor-generator, and
the switch device controls the batteries of the battery pack via the switches based on the command signal.

5. The power system of claim 4 further comprising:
the power control module outputs a first command signal to the switch device when the motor-generator is being operated as the motor, the first command signal indicates two or more batteries to be coupled in series and to the motor-generator, and
the power control module outputs a second command signal to the switch device when the motor-generator is being operated as the generator, the second command signal indicates one or more batteries to be connected to the motor-generator for charging.

6. The power system of claim 1 wherein the switch device is electrically coupled to one or more accessory devices disposed in the vehicle and the switch device electrically couples at least one of the batteries of the battery pack to the one or more accessory devices to supply power to the accessory devices.

7. The power system of claim 6 wherein:
the switch device electrically couples a first battery set to the switch device and a second battery set different from the first battery set to the motor-generator, and
the first battery set and the second battery set include one or more batteries from among the plurality of batteries of the battery pack.

8. The power system of claim 1 wherein:
the motor-generator operates as the generator when the compressor is being drive by an internal combustion engine disposed in the vehicle, and the motor-generator operates as the motor when the engine is stopped due to an idle state of the vehicle.

9. The power system of claim 1 wherein the switches are metal-oxide-semiconductor field-effect transistors.

10. A system for a vehicle, the system comprising:
an air conditioning system including a compressor driven by an internal combustion engine; and
a power system including:
a battery pack having a plurality of batteries,
a switch device including a plurality of switches, wherein the switches are electrically coupled to each of the batteries of the battery pack and are operable to control each of the batteries of the battery pack, and
a motor-generator electrically coupled to the switch device, wherein the motor-generator is operable as a generator to charge the batteries in the battery pack and as a motor to drive the compressor when the engine is stopped during an idle state of the vehicle.

11. The system of claim 10 wherein the power system further comprises:
a power control module that controls the switch device and the motor-generator, wherein:
the power control module operates the motor-generator as the motor to drive the compressor when the engine is stopped and operates the motor-generator as the generator to charge the batteries of the battery pack when the engine is ON,
the power control module outputs a command signal to the switch device, the command signal identifies one or more batteries to be coupled to the motor-generator, and
the switch device operates one or more of the plurality of switches to control the batteries of the battery pack based on the command signal.

12. The system of claim 11 wherein:
the power control module outputs a first command signal to the switch device when the motor-generator is being operated as the motor, the first command signal indicates two or more batteries to be coupled in series and to the motor-generator, and
the power control module outputs a second command signal to the switch device when the motor-generator is being operated as the generator, the second command signal indicates one or more batteries to be connected to the motor-generator for charging.

13. The system of claim 10 further comprising:
one or more accessory devices electrically coupled to the switch device, wherein the switch device electrically couples at least one of the batteries of the battery pack to the one or more accessory devices to supply power to the accessory devices.

14. The system of claim 13 wherein:
the switch device electrically couples a first battery set to the switch device and a second battery set different from the first battery set to the motor generator, and
the first battery set and the second battery set include one or more batteries from among the plurality of batteries of the battery pack.

15. The system of claim 10 wherein the switches of the switch device are metal-oxide-semiconductor field-effect transistors.

16. The system of claim 10 wherein the switch device electrically couples two or more batteries in series and to the motor-generator to provide power to the motor-generator.

17. The system of claim 10 wherein the switch device electrically couples two or more batteries in parallel and to the motor-generator to charge the batteries via the motor-generator.

18. The system of claim 10 wherein the power system moves the vehicle by way of the motor-generator when the engine is stopped to perform a creep operation.
